(19) United States
(12) Patent Application Publication
(10) Pub. No.: US 2013/0315695 A1
(43) Pub. Date: Nov. 28, 2013

(54) AUTOMATED VEHICLE LOADING APPARATUS

(71) Applicant: Eldon Meyers, Corwith, IA (US)

(72) Inventor: Eldon Meyers, Corwith, IA (US)

(21) Appl. No.: 13/901,053

(22) Filed: May 23, 2013

Related U.S. Application Data
(60) Provisional application No. 61/651,129, filed on May 24, 2012.

(51) Int. Cl. B60P 1/43; B60P 3/07

(52) U.S. Cl. CPC B60P 1/43; B60P 3/07
USPC 414/491

(57) ABSTRACT

An automated vehicle loading apparatus comprises a power source, a motor, a carrier, a guide, a direct drive, and a control means. A vehicle may be driven until it is situated within the carrier, at which point the direct drive may move the vehicle in a forward direction until it is loaded within a trailer or onto a flatbed track. The direct drive may thereafter move the vehicle in a rearward direction until it is unloaded therefrom. The apparatus further provides for the selective stopping of a vehicle in an intermediary position regardless of forces of gravity or slope. The control means may include a remote controller or a direct controller. The apparatus may further comprise a vehicle housing, such as a trailer or flatbed, within or onto which a vehicle may be loaded, or the apparatus may instead be retrofit with an existing trailer or flatbed.

### CROSS-REFERENCE TO RELATED APPLICATIONS

The present application claims priority under 35 USC §119 on pending U.S. Provisional Patent Application Ser. No. 61/651,129, filed on May 24, 2012, the disclosure of which is incorporated by reference.

### FIELD OF THE DISCLOSURE

The present disclosure generally relates to apparatuses for loading vehicles, and more particularly, to an automated vehicle loading apparatus for loading a vehicle onto and offloading a vehicle from a location such as a trailer platform.

### BACKGROUND

When not being driven themselves, vehicles may generally be transported by way of a flatbed tow truck or trailer. Vehicles may need to be transported by such flatbed tow trucks or trailers where they are non-operational or in need of repair, for instance, if they are not “street-legal” and are being transported to a race track, or alternatively where they need to be sequestered from the elements and maintained in a pristine condition for display at an auto show, auction, or other event. The transporting flatbed tow truck or trailer may be either an open or enclosed structure, which structure when enclosed may avoid any undesirable wear and tear on the vehicle such as that as may be caused by driving the vehicle over a long distance, in hazardous weather conditions, along dilapidated roads, or in a variety of other dangerous situations.

Obviously, such a trailered or towed vehicle must be loaded onto the tow truck flatbed or trailer before it can be moved thereby. Existing systems and methods for loading and unloading vehicles usually involve a winch and cable arrangement, by which a cable is first attached to the vehicle or dolly and a winch thereafter winds the cable, which winding pulls the vehicle onto the trailer or flatbed truck, and which subsequent unwinding of the cable allows the vehicle to roll off of the trailer or flatbed truck. However, the winch and cable arrangement suffers from many serious disadvantages. In particular, the winch and cable arrangement cannot on its own exert a force on a vehicle in an unloading direction. That is, to unload a vehicle from a trailer or flatbed truck, the winch and cable arrangement must rely on the force of gravity to accomplish the lowering and unloading. Therefore, the winch and cable arrangement sacrifices the highly desirable full control over the vehicle during the unloading process.

Further, the attachment of the cable to the vehicle or rolling dolly can present a dangerous situation. That is, the cable is usually attached to the vehicle by way of a hook at an end thereof, which hook specifically attaches to a ring or other engagement feature disposed on the frame or undercarriage of the vehicle. Given the weight of the vehicle, a significant amount of stress is thereby placed on the cable during the loading and unloading processes. Should the cable fray or otherwise become damaged, the risk of the cable breaking during the loading and unloading processes increases. In the event that the cable does break, or simply comes unhooked, the vehicle, the trailer, and/or any bystanders could suffer serious damage or injury.

Risks are present when rolling weight encounters on an inclined ramp. For example, the use of a winch and cable arrangement, and, specifically, the attachment of the cable thereof to the vehicle, fails to provide any precision in the control of movement of the vehicle while it is being loaded or unloaded. Rather, the movement of the vehicle is dependent on the cable's own movement, if any, as it winds onto or unwinds off of the winch. Because such control is generally lacking, the user must remain within the vehicle or, alternatively, in sufficient proximity to the vehicle so as to steer it while it is being loaded in order to ensure that the vehicle does not stray away from the center of gravity, or completely off of the flatbed truck or trailer altogether. It is also preferable in these arrangements for a user to have access to the brakes of the vehicle in case the vehicle breaks loose from the cable or to add a degree of control to the unloading process. However, requiring the user to remain in or near the vehicle for such ends is problematic particularly when the trailer comprises an enclosed structure. That is, once the vehicle is loaded, there may be insufficient space within the trailer for the user to easily exit the vehicle, or for the user to re-enter it in order to subsequently unload it therefrom. Further, such a requirement involves the potentially dangerous act of walking alongside the vehicle while it is in motion.

Of course, the user may situate the vehicle to one side in order to provide enough space to enter and exit the vehicle within the trailer; however, this too is problematic, as doing so falsely centers the weight of the vehicle within the trailer, which poses a serious detriment to the safety and handling of the trailer while in motion. Similarly, a trailer that is significantly larger than the vehicle being transported therein may be used, which would provide enough room to enter and exit it thereon. However, an otherwise unnecessarily large trailer poses its own risks on the road, including increasing the haul weight and gasoline consumption thereof.

Thus, while existing solutions allow vehicles to be loaded and unloaded to some extent, various drawbacks, including those mentioned above, remain.

Accordingly, a need exists for an automated vehicle loading apparatus that overcomes the disadvantages of the prior art, while maintaining the benefits of the prior art. A further need exists for an automated vehicle loading apparatus that does not require the user to be inside, in proximity to, or in manual control of the vehicle while the vehicle is being loaded or unloaded, or that does not require that loading surfaces and/or surrounding terrain be level. Moreover, a need exists for an automated vehicle loading apparatus that allows for the safe loading and unloading of a vehicle by way of a linear actuator, thereby obviating the cable and winch arrangement.

### SUMMARY OF THE INVENTION

In view of the foregoing disadvantages of the prior art, an automated vehicle loading apparatus configured to include all the advantages of the prior art and to overcome the drawbacks inherent therein is provided. The apparatus uses a direct drive linear actuator, rather than a winch and cable arrangement, which direct drive may be coupled to a motor powered by a power source in order to move a vehicle coupled to the apparatus in the forward and rearward directions. Accordingly, the direct drive provides for the full control of lateral movement of the vehicle being loaded within or onto or unloaded from a trailer or flatbed trick regardless of forces of gravity or slope, including providing for the selective stopping of the vehicle during the loading and unloading procedures. The apparatus is further capable of safely loading a vehicle into and unloading a vehicle from a trailer or flatbed truck without requiring a driver to be within the car or in proximity thereto. In this way, the apparatus overcomes the aforementioned spatial issues that interfere with one's ability to get out of the vehicle once it is loaded into the trailer or get into the vehicle when the vehicle is ready to be unloaded therefrom.

In an embodiment, an automated vehicle loading apparatus comprises a power source, a motor, at least one carrier, at least one guide, at least one direct drive, and a control means. The power source may be any component capable of powering the apparatus. The at least one carrier includes a mechanism for receiving at least a portion of a vehicle, which carrier is disposed within the at least one guide. The at least one direct drive is capable of moving the vehicle in the forward and rearward directions and is coupled to the at least one carrier and the motor. In an embodiment, the at least one direct drive is a spindle drive and shaft arrangement. In another embodiment, the at least one direct drive is a rack and pinion arrangement. In yet another embodiment, the at least one direct drive is an internal belt drive arrangement. The control means is coupled to the at least one direct drive and the motor, controls the movement of the direct drive, and may comprise either or both of a remote controller and a direct controller.

In a further embodiment, the apparatus may comprise a vehicle housing, which may be a trailer, enclosure, flatbed, or other platform within or on top of which the vehicle may be loaded. In this embodiment, the apparatus is operatively coupled within the vehicle housing. In a further embodiment, the vehicle housing may further comprise the platform onto which the vehicle is loaded. The apparatus may be externally configured on top of the platform or internally within it. In another embodiment, the apparatus does not comprise a vehicle housing, but rather may be retrofit within an existing vehicle storage unit, such as a trailer, enclosure, flatbed, or other platform within or on top of which the vehicle may be loaded. Similarly, the apparatus may be externally configured on top of a platform of the vehicle storage unit or internally configured within such platform.

Regardless of the inclusion of a vehicle housing and in a further embodiment, the apparatus may further comprise at least one ramp for allowing the vehicle to access the at least one carrier of the apparatus. In this embodiment, the ramp, which may be connected to a vehicle housing or vehicle storage unit by either hinged attachment or slidable extension at a proximate end thereof, may additionally form the rear wall of the vehicle housing or vehicle storage unit similar to that of an enclosure or trailer.

In a further embodiment, the apparatus may comprise a sensor, or “kill switch,” which sensor is coupled to the motor and the at least one direct drive. During the loading procedure and upon the direct drive moving the vehicle to a predetermined location within the vehicle housing or vehicle storage unit, the sensor will stop the direct drive by deactivating the motor. In this way, the apparatus ensures that the vehicle cannot be loaded beyond a safe point within the trailer or onto the flatbed truck, which might otherwise involve the vehicle coming into contact with a back wall at a distal end of the trailer or falling off of a distal end of the flatbed truck, thereby resulting in damage to the apparatus, the vehicle, or both.

In a further embodiment, the at least one direct drive of the apparatus may provide for the selective stopping of a vehicle in an intermediary position that is defined at some location during the loading and unloading procedures. The at least one direct drive may thus maintain the vehicle in such intermediary position for an indefinite period of time without any risk of harm being posed to the apparatus, the vehicle, or both.

In a further embodiment, the at least one carrier may further comprise at least one retention mechanism, which receives a portion of the vehicle stored thereon and securely retains the vehicle thereto during the loading and unloading procedures and at any selective intermediary position there between. The at least one retention mechanism safely maintains the vehicle on the at least one guide and may comprise either or both of a wheel basket and a wheel fastener.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 shows a perspective view of an automated vehicle loading apparatus in accordance with an exemplary embodiment of the present disclosure;

FIG. 2 shows a cross-sectional view of an automated vehicle loading apparatus in accordance with an exemplary embodiment of the present disclosure;

FIG. 3A shows an exemplary embodiment of the apparatus wherein the at least one direct drive comprises a rack and pinion arrangement;

FIG. 3B shows an exemplary embodiment of the apparatus wherein the at least one direct drive comprises an internal belt drive arrangement;

FIG. 4 shows an exemplary embodiment of the at least one carrier and the at least one guide of the apparatus; and

FIG. 5 shows a perspective view of the apparatus having been retrofit within an existing vehicle storage unit in accordance with an exemplary embodiment of the present disclosure.

### DETAILED DESCRIPTION OF THE DISCLOSURE

The best mode for carrying out the present disclosure is presented in terms of its preferred embodiments, herein depicted in the accompanying figures. The preferred embodiments described herein detail for illustrative purposes are subject to many variations. It is understood that various omissions and substitutions of equivalents are contemplated as circumstances may suggest or render expedient but are intended to cover the application or implementation without departing from the spirit or scope of the present disclosure.

The terms “a” and “an” herein do not denote a limitation of quantity, but rather denote the presence of at least one of the referenced items.

The present disclosure comprises an automated vehicle loading apparatus for the safe loading and unloading of a vehicle onto or within and from a flatbed tow truck, trailer, or other platform. In an embodiment, the apparatus comprises at least one direct drive, such as a spindle drive and shaft arrangement, a rack and pinion arrangement, or an internal belt drive arrangement, which direct drive is a linear actuator capable of applying a force on a vehicle in the forward and rearward directions and of further selectively stopping the vehicle in and maintaining it at an intermediary position regardless of forces of gravity or slope. The apparatus further comprises at least one carrier, which at least one carrier is operatively coupled to and actuated by the at least one direct drive, and which at least one carrier may receive at least a portion of the vehicle to be loaded or unloaded by the apparatus.

The at least one direct drive and at least one carrier are powered by a power source that powers a motor, and the at least one carrier is contained within or disposed on at least one guide, which at least one guide may be a track, channel or wall used for restricting the range of movement of the at least one carrier. The apparatus may be retrofit within an existing vehicle storage unit, such as a trailer or flatbed tow truck, or may comprise its own vehicle housing. The apparatus allows for the safe loading and unloading of a vehicle by applying a controlled force thereon during both the loading and unloading processes, which controlled force is exerted via the at least one direct drive and the power source, which components are coupled to a control means.

In use, and during a loading procedure, the control means directs the power source of the apparatus to cause the motor to operate the at least one direct drive to impart a linear motion on the at least one carrier in the forward direction, which motion is translated along the at least one guide and causes the vehicle to become loaded within or onto the vehicle housing. Similarly, during an unloading procedure, the control means directs the power source to cause the motor to operate the at least one direct drive to impart a linear motion on the at least one carrier in the rearward direction, which motion is translated along the at least one guide and causes the vehicle to become unloaded from the vehicle housing.

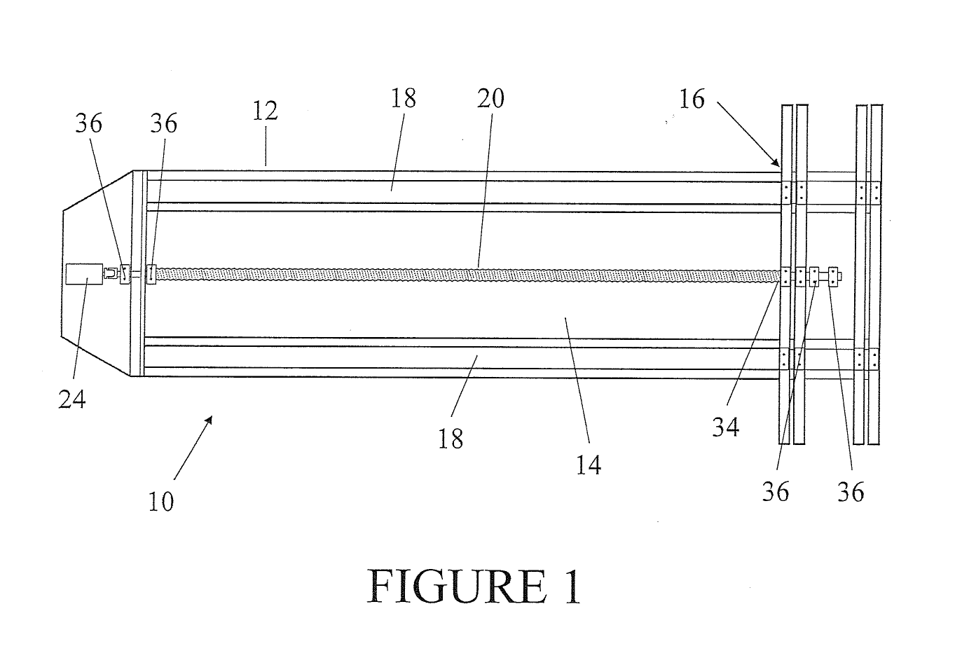

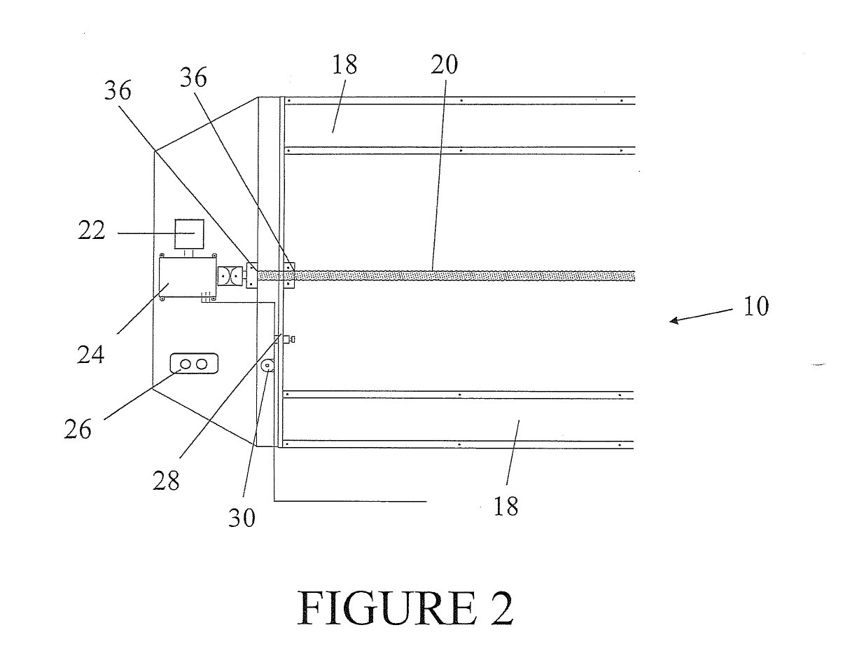

Referring now to FIGS. 1 and 2, and in an embodiment, an automated vehicle loading apparatus is shown at 10, which apparatus 10 is capable of loading a vehicle (not shown in the Figures) within or onto a vehicle housing 12. The vehicle housing 12 may be formed by either an open or an enclosed structure, and, regardless of its formation, provides a platform 14 that may be a floor or bed on top of which the vehicle is contained. The vehicle housing 12 may also comprise fitted channels within which the various components of the apparatus 10 may be internally situated, or those components may instead be externally disposed on top of the platform 14. The vehicle housing 12 has a receiving end comprising an opening large enough to receive the vehicle, which receiving end is generally located at the rear of the vehicle housing 12.

A carrier 16 is contained within the vehicle housing 12, which carrier 16 is designed to receive at least a portion of the vehicle and remains in close proximity to the platform 14 of the vehicle housing 12. In an embodiment, the carrier 16 receives only the wheels of the vehicle. In a further embodiment, a plurality of carriers 16 may be used with the apparatus 10. The carrier 16 is movably disposed on top of or within a guide 18, which guide 18 directs the forward movement of the carrier 16 as the vehicle is loaded within or onto the vehicle housing 12 and the rearward movement of the carrier 16 as the vehicle is unloaded from the vehicle housing 12, and which guide 18 acts as a track or wall to prevent the movement of the carrier 16 from straying therefrom. In a preferred embodiment, two guides 18 are used, with one guide 18 forming a track on the driver side of the vehicle and the other guide 18 forming a track on the passenger side of the vehicle, which guides 18 allow the sides of the vehicle to move collinearly.

A direct drive 20 is operatively coupled to the carrier 16 and imparts a linear motion on the carrier 16 in the forward and rearward directions and, in an embodiment, in a stepwise fashion therein. The direct drive 20 is a linear actuator and, as will be discussed below, may comprise a spindle drive and shaft arrangement a rack and pinion arrangement, or an internal belt drive arrangement. The direct drive 20 directs the movement of the carrier 16 along the predictable path of the guides 18. In an exemplary embodiment, the apparatus 10 may comprise two direct drives 20 wherein each such direct drive 20 is disposed within one of the two guides 18.

The direct drive 20 is powered by a power source 22, which may be any source capable of powering the apparatus 10 and specifically for providing power to a motor 24. The motor 24 is capable of causing the direct drive 20 to move in either the forward or the rearward direction. The motor 24 is preferably disposed at the distal end of the vehicle housing 12, although it may alternatively be disposed at any location thereof so long as it remains coupled to the direct drive 20. Also coupled to the motor 24 is a control means 26 that provides a user with full control over the direct drive 20 and therefore the carrier 16. The control means 26 may itself comprise one or both of a direct controlling system physically attached to the apparatus 10 and a remote control unit that is separated therefrom. In a preferred embodiment, the control means 26 at least includes a remote control unit, which allows a user to operate the apparatus 10 without being in immediate proximity to the vehicle or the apparatus 10.

A user must first drive the vehicle until it is received within the carrier 16 before the apparatus 10 can begin the loading procedure. Once the vehicle is in place within the carrier 16, the user may operate the control means 26, which allows the user to selectively activate the motor 24 and direct drive 20 and thereby actuate the carrier 16 to move in the forward direction to load the vehicle within or onto the vehicle housing 12. The direct drive 20 will move the carrier 16 forward within or onto the vehicle housing 12 until the user terminates operation of the control means 26 or until the carrier 16 comes into contact with a sensor 28, which sensor 28 is disposed at some location on the distal end of the vehicle housing 12.

The sensor 28 acts as a kill switch by deactivating the motor 24 upon the vehicle reaching a predetermined position within or on top of the vehicle housing 12 and therefore prevents the vehicle and the carrier 16 from coming into contact with the distal end of the vehicle housing 12. The sensor 28 further overrides the control means 26. The sensor 28 prevents movement of the carrier 16 beyond a safe receiving location within or on top of the vehicle housing 12, thereby precluding injury to one or both of the apparatus 10 and the vehicle. In an embodiment, the control means 26 may automatically reset the sensor 28 after the overriding the control means 26 such that the user would not be required to manually reset it. Additionally, a safety alarm 30 is provided, which safety alarm 30 produces an audible tone to alert the user when the apparatus 10 is being powered by the power source 22.

In the exemplary embodiment as shown in FIGS. 1 and 2, the direct drive 20 is a spindle drive and shall arrangement wherein a spindle is centrally disposed at the distal end of the vehicle housing 12 and is operatively coupled to a distal end of a shaft. The carrier 16 is also operatively coupled to the shaft at a dynamic position thereon, which position is a proximate end of the shaft before the loading procedure is commenced and is the distal end of the shaft before the unloading procedure is commenced. Specifically, the coupling between the shaft and the carrier 16 comprises a nut 34 disposed on the carrier 16 through which the shaft may be rotated by the spindle. In a preferred embodiment, the carrier comprises two nuts 34 for coupling with the shaft. The spindle rotates using power from the motor 24, which rotation imparts a linear motion on the carrier 16 when the threads of the shall exert a pressure on the nut 34 of the carrier 16. This motion may be stepwise and may move the carrier 16 in either the forward or rearward direction depending on the direction of rotation of the spindle. The shaft is preferably contained by at least one bearing 36 proximate to each end of the shaft, which bearing 36 facilitates the controlled rotational motion of the shaft and which bearing 36 otherwise supports and restricts the positioning of the shaft within the apparatus 10.

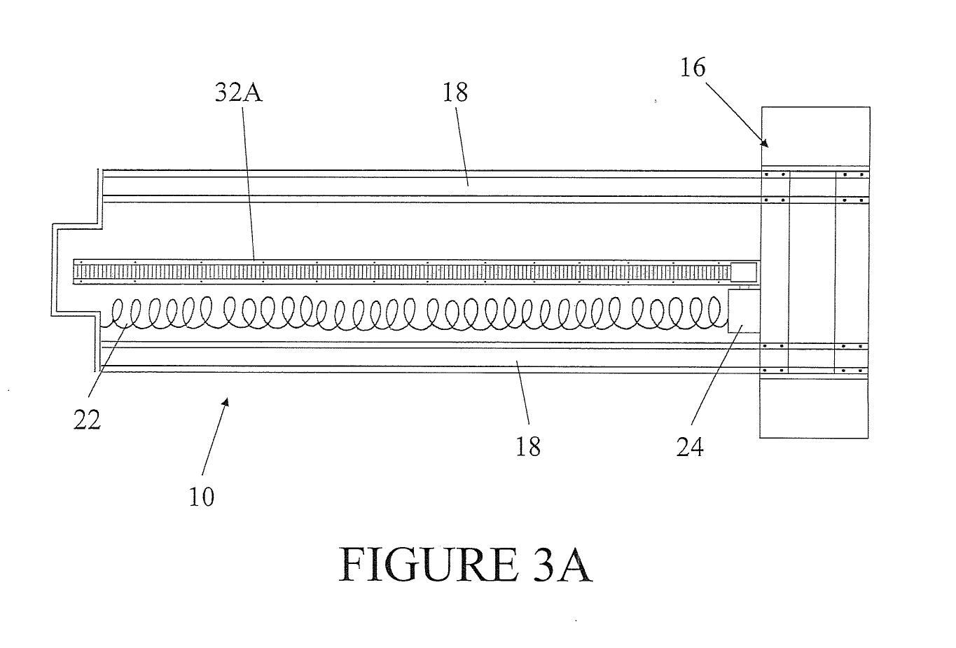

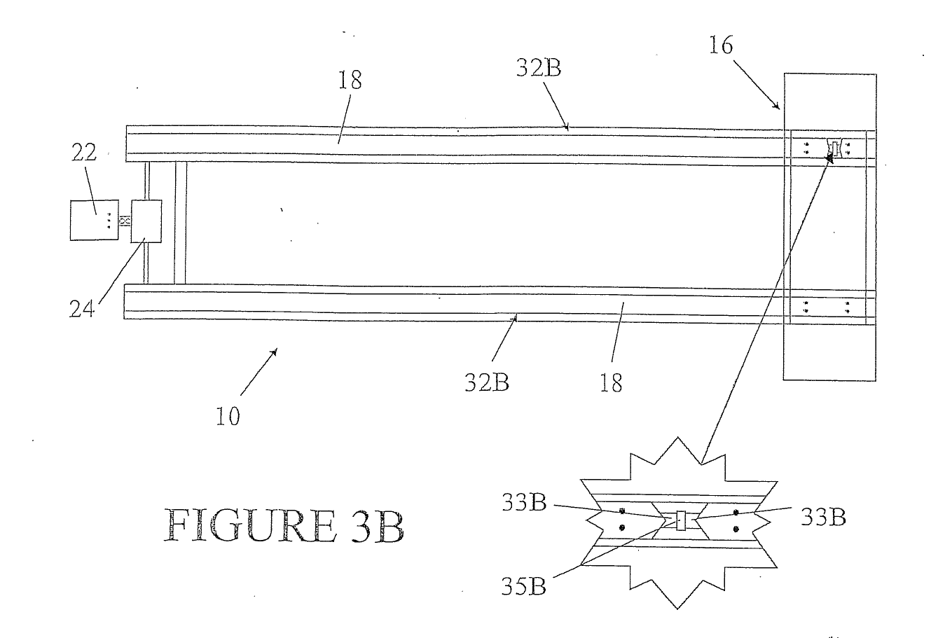

Further embodiments of the direct drive 20 are illustrated in FIGS. 3A and 3B, wherein FIG. 3A depicts a direct drive 20 comprising a rack and pinion arrangement 32A and FIG. 3B depicts a direct drive 20 comprising an internal belt drive arrangement 32B. The rack and pinion arrangement 32A of FIG. 3A provides for the linear conversion and actuation mechanics of the direct drive 20 wherein a rack is centrally disposed along the length of the vehicle housing 12 and engagingly receives a pinion. In an embodiment, a plurality of pinions may be received by the rack. The carrier 16 is operatively coupled to the pinion, which coupling allows the carrier 16 to traverse the duration of the rack uninterruptedly. The rack is coupled to the motor 24, which engages the rack in a conveyance motion that causes the pinion to move the carrier 16 in either the forward or rearward direction depending on the direction of conveyance. The pinion is preferably contained by at least one bearing 36 proximate to each end of the rack, which bearing 36 facilitates the controlled conveyance motion of the rack and which bearing 36 otherwise supports and restricts the positioning of the rack within the apparatus 10.

The internal belt drive arrangement 32B of FIG. 3B (shown in a cutaway view of the carrier) comprises a belt 33B and an engagement feature 35B. In an embodiment, multiple belts 33B and engagement features 35B may be used with the apparatus 10, with each such belt 33B coupling with the carrier 16 via one or more engagement features 35B. The carrier 16 is operatively coupled to the internal belt drive arrangement 32B via the engagement feature 35B, which coupling allows the carrier 16 to be moved by the belt 33B along the length of the guide 18. In a preferred embodiment, the internal belt drive arrangement 32B comprises two belts 33B and the apparatus 10 comprises two guides 18. The belt 33B is coupled to the motor 24 (by way of a pulley arrangement, for example), which drives the belt 33B, thereby causing the engagement feature 35B to move the carrier 16 along the length of the guide(s) 18 in either the forward or rearward direction depending on the direction of actuation of the belt 33B. In an embodiment, the belt 33B is disposed above the platform 14 of the vehicle housing 12. In a further embodiment (and as shown in FIG. 3B), the belt 33B is disposed within the platform 14. It will be apparent that the belt 33B will be disposed in sufficient proximity to the guide 18 in order to constrain the directional movement of the carrier 16. In a preferred embodiment, only engagement feature 35B extends above the platform 14, and belt 33B remains within the platform.

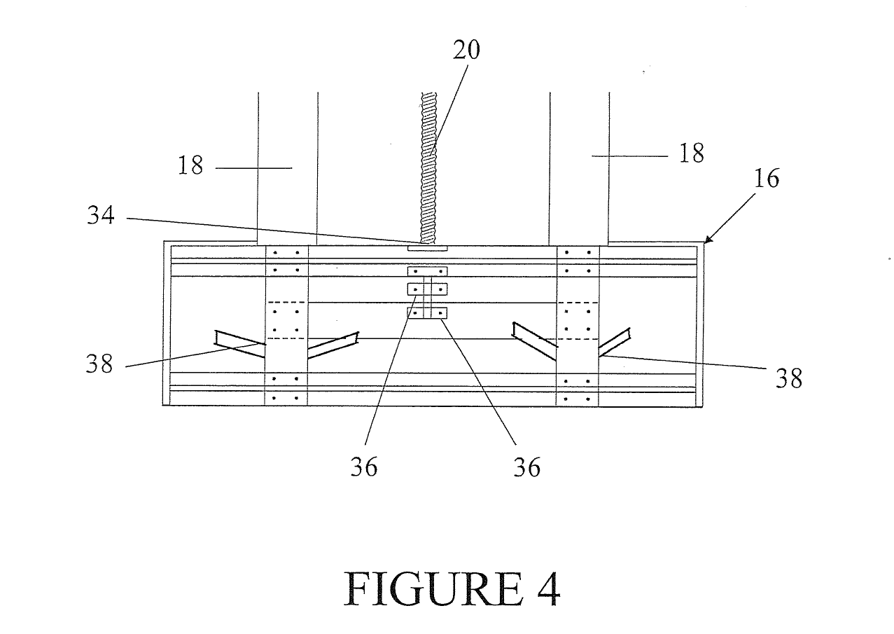

FIG. 4 provides a larger view of the carrier 16 of the apparatus 10, which figure shows the retention mechanism 38 utilized by the carrier 16 to securely retain the vehicle thereto during the loading and unloading procedures. In an embodiment, the retention mechanism 38 comprises a wheel basket for receiving and retaining a wheel of the vehicle to be loaded or unloaded by the apparatus 10. In a preferred embodiment in which the retention mechanism 38 is a wheel basket, the carrier 16 comprises two such wheel baskets wherein each front wheel of the vehicle may be received by one wheel basket. In a further embodiment, the retention mechanism 38 comprises a wheel fastener, which is a strapping, netting, or other fastener means that similarly securely retains the vehicle to the carrier 16. In a preferred embodiment wherein the retention mechanism 38 is a wheel fastener, two wheel fasteners are used, one with each front wheel of the vehicle. The user secures the wheel fasteners around the wheels and tires of the vehicle after it is loaded onto the carrier 16, and, in an embodiment wherein the retention mechanism 38 comprises both wheel fasteners and wheel baskets, the user first secures each wheel into a wheel basket prior to securing the wheel fasteners about them.

It will be apparent that mechanisms other than wheel baskets and wheel fasteners may be used to provide for receiving and retaining a wheel of the vehicle to be loaded and unloaded, which other mechanisms will also be operatively coupled to or incorporated on the carrier 16 to enable movement of the mechanisms. For example, a wheel dolly or dollies may be used to further retain the wheels of the vehicle within the carrier 16. In an embodiment, the various retention mechanisms 38 and other mechanisms may be operated using the control means 26 in order to further automate that particular aspect of the loading and unloading processes.

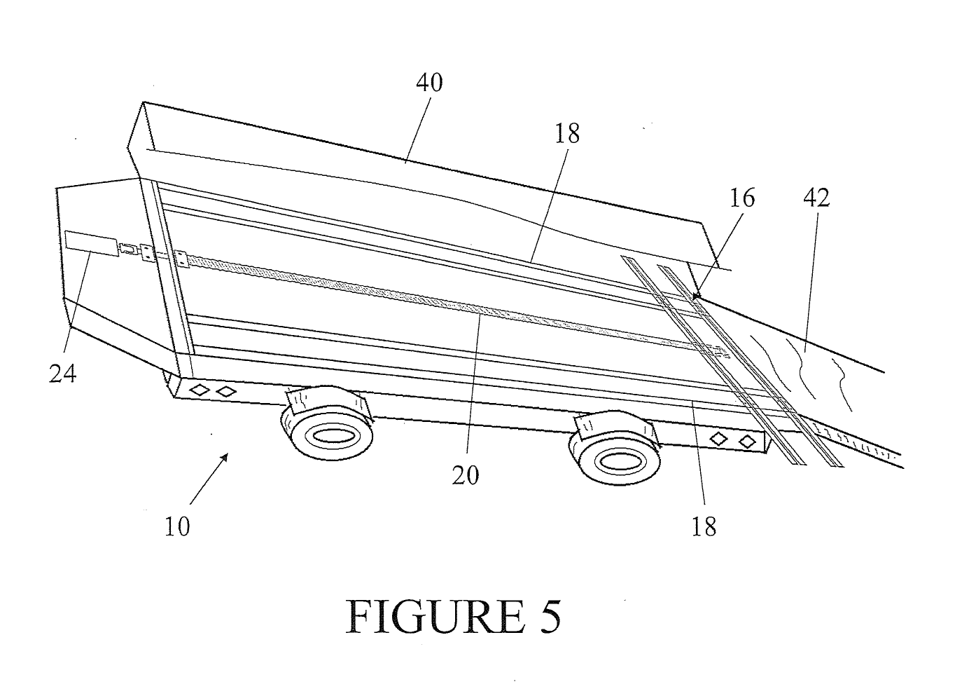

As described above and in an embodiment, the apparatus 10 may be configured to include a vehicle housing 12 for receiving and containing the vehicle loaded therein or thereon. However, as shown in FIG. 5, and in a further embodiment, the apparatus 10 does not include a vehicle housing 12, but instead may be configured to retrofit within or onto an existing vehicle storage unit 40, which vehicle storage unit 40 may be a trailer, flatbed tow truck, or any other open or enclosed (such as the enclosure or covering, shown in a cutaway view, in FIG. 5) vehicle transportation device comprising at least a platform. In this retrofit embodiment, the carrier 16, the guides 18, and the direct drive 20 may be coupled to the existing platform of the vehicle storage unit 40. Further, the various components of the apparatus 10 may be appropriately configured and dimensioned to allow the apparatus 10 to function within the dimensional confines of any existing vehicle storage unit 40.

In an embodiment and where the vehicle storage unit 40 lacks its own, the apparatus 10 includes a ramp 42 that provides an access means for the vehicle to be loaded within or onto the vehicle storage unit 40 and subsequently unloaded therefrom. The ramp 42 is either hingably attached to or slidably extended from a proximate end of the vehicle storage unit 40. The ramp 42 must further be sturdy enough to withstand the full weight of the vehicle placed thereon. In an embodiment, the apparatus 10 may comprise two ramps 42, each of which may correspond generally to the orientation of the vehicle's wheels and axle widths and may thus accommodate the wheels on a single side of the vehicle. It will be apparent that the vehicle housing 12 shown in the previous figures is also capable of including a ramp 42 that provides an access means for the vehicle to be loaded within or onto the vehicle housing 12 and subsequently unloaded therefrom. The ramp 42 is either hingably attached to or slidably extended from the rest of the vehicle housing 12 as it is with the vehicle storage unit 40 and, in an embodiment wherein the vehicle housing 12 is an enclosed structure, may form the rear wall of the vehicle housing 12 by hinging upwardly to enclose the interior of the vehicle housing 12.

The apparatus 10 may become retrofitted within or onto an existing vehicle storage unit 40 in at least one of two configurations. First, the apparatus 10 may be externally configured onto the platform of the vehicle storage unit 40 by fixedly attaching each of the various components thereof thereon. Second, the apparatus 10 may be internally configured within the platform of the vehicle storage unit 40 by producing channels therein that are sizably fitted to receive each individual component thereof. The first configuration is preferable, as it requires significantly less work to achieve, obviates the use of heavy or cutting machinery, and does not materially alter the vehicle storage unit 40.

In order for the vehicle to be loaded within the vehicle housing 12 or vehicle storage unit 40 by the apparatus 10, the user must first lower or extend the ramp 42 to allow the vehicle to access the platform 14 on which it will be transported. The carrier 16 is initially positioned at a proximate end of the vehicle housing 12 or vehicle storage unit 40 and in particular is adjacent to the ramp 42. Once the ramp 42 and carrier 16 are in place, the user may drive the vehicle up the ramp 42 until the wheels are positioned within or on the carrier 16, and specifically within the retention mechanism 38 thereof. The user may then engage the parking brake of the vehicle until the wheels thereof are securely retained within the retention mechanism 38, at which point the parking brake may be disengaged.

Once the vehicle 12 is engaged on the carrier 16, the user may operate the control means 26 to power the direct drive 20, which action will actuate the carrier 16 in a stepwise motion to move the vehicle towards the distal end of the vehicle housing 12 or vehicle storage unit 40, thereby loading the vehicle therein or thereon. That is, the carrier 16 will move the wheels of the vehicle that have been received thereon, which movement will cause the entire vehicle to move up the ramp 42 and into or onto the vehicle housing 12 or vehicle storage unit 40. Once the user determines that the carrier 16 has moved the vehicle to a far enough position within or on top of the vehicle housing 12 or vehicle storage unit 40, or once the sensor 28 has deactivated the motor 24 thereby precluding further forward movement of the carrier 16, movement of the carrier 16 will cease and the user may secure the vehicle to the vehicle housing 12 or vehicle storage unit 40 as may be necessary and close any open sides where the structure is of an enclosed form.

To unload, the vehicle from the vehicle housing 12 or vehicle storage unit 40 using the apparatus 10, the user must first open any enclosed sides through which the vehicle will be received, unsecure the vehicle to the vehicle housing 12 or vehicle storage unit 40 as may be necessary, and lower or extend the ramp 42. Once that is done, the user may operate the control means 26 to power the direct drive 20, which action will actuate the carrier 16 in a stepwise motion to move the vehicle towards the proximate end of the vehicle housing 12 or vehicle storage unit 40, thereby unloading the vehicle therefrom. Once the carrier 16 has reached its most proximate position, the user may release the wheels of the vehicle from the retention mechanism 38 of the carrier 16, enter the vehicle, and drive it off of the ramp 42 and away from the vehicle housing 12 or vehicle storage unit 40.

The apparatus 10 is further capable of selectively stopping the vehicle at any intermediate position during the loading and unloading procedures, which selective stopping will safely maintain the vehicle at such intermediate position until the user directs the further actuation of the carrier 16, regardless of forces of gravity or slope. That is, the direct drive 20 is designed to provide for stepwise movement of the carrier 16 in the forward and rearward directions. Thus, by using the control means 26, the user may stop the direct drive 20 from actuating the movement of the carrier 16 at any position of the loading and unloading processes. This aspect of the apparatus 10 ensures that the vehicle will remain undamaged in the event that certain components of the apparatus 10 fail during operation and further allows the user to direct their attention elsewhere as may be necessary during the loading and unloading procedures.

The apparatus disclosed herein provides various advantages over the prior art. It allows controlled loading and unloading of a vehicle within or onto and off of a trailer or flatbed truck, and accomplishes such loading and unloading by exerting a force other than the force of gravity on the vehicle. The direct drive allows for directed loading and unloading of the vehicle and assists in keeping the vehicle in a position when the direct drive is not actuating the carrier. The loading and unloading processes can be accomplished without requiring the user to be in or in proximity to the vehicle. Thus, the apparatus eliminates the issue of a lack of space in the trailer that otherwise makes it difficult, if not impossible, for user to enter or exit the vehicle while the vehicle is on or within the trailer. Further, the controlled loading accomplished by the direct drive and carrier also reduces the possibility of slippage or other undesirable movement of the vehicle including the unwanted rolling of the vehicle off of the trailer, thus reducing the possibility of damage to the vehicle and injury to bystanders. In the case where the direct drive is a spindle drive and shaft arrangement, slippage is prevented by pure spindle efficiency dynamics—that is, when power is applied to the spindle, it acts as a drive mechanism. When power is interrupted, the spindle acts as a fastener. Where the direct drive comprises a rack and pinion arrangement or an internal belt drive arrangement, slippage is prevented by integral braking.

The apparatus, in providing for controlled loading, unloading, and positioning of a vehicle in or on a trailer, provides for improved and centralized weight distribution therein or thereon, which improves ease of use by and safety for the driver hauling the trailer and vehicle. Further, because spatial requirements are no longer a concern for the user as to being able to exit the vehicle once it is loaded in or on the trailer, the apparatus facilitates the use of smaller dimensioned trailers, which smaller-dimensioned trailers provide for better fuel economy and reduced drag during transport, safer handing and braking while driving and pulling the trailer, and for easier positioning and parking of such trailers.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. An automated vehicle loading apparatus, said apparatus comprising:
a power source;
a motor;
at least one carrier, said at least one carrier capable of receiving at least a portion of a vehicle;
at least one guide, said at least one carrier operatively coupled to said at least one guide;
at least one direct drive, said at least one direct drive capable of moving said at least one carrier in at least two directions;
a control means; and
a vehicle housing, said vehicle housing forming at least a partial enclosure around the vehicle, said vehicle housing containing at least as portion of said apparatus, said vehicle housing capable of receiving at least a portion of the vehicle,
wherein during a loading procedure, said control means directs said power source to cause said motor to operate said at least one direct drive to move said at least one carrier within said at least one guide in a direction along said at least one guide from a first position to a second position such that the vehicle may be at least partially received by said vehicle housing, and
wherein during an unloading procedure, said control means directs said power source to cause said motor to operate said at least one direct drive to move said at least one carrier within said at least one guide in a direction along said at least one guide from a second position to a first position such that the vehicle may be at least partially removed from said vehicle housing.

2. The apparatus as claimed in claim 1, wherein said at least one direct drive comprises one of a spindle drive and shaft arrangement, a rack and pinion arrangement, and an internal belt drive arrangement.

3. The apparatus as claimed in claim 1, wherein said apparatus further comprises sensor, said sensor capable of deactivating said power source or directing said control means to deactivate said power source upon the vehicle reaching a predetermined received position within said vehicle housing, said sensor capable of overriding said control means.

4. The apparatus as claimed in claim 1, wherein said control means comprises at least one of remote controlling and direct controlling.

5. The apparatus as claimed in claim 1, wherein said vehicle housing includes at least one ramp, said at least one ramp forming a surface upon which a user may drive the vehicle to access said at least one carrier, said at least one ramp disposed at an end of said vehicle housing.

6. The apparatus as claimed in claim 5, wherein said at least one ramp is connected to said vehicle housing by one of hinged attachment and slidable extension.

7. The apparatus as claimed in claim 1, wherein said at least one carrier further comprises at least one retention mechanism, said at least one retention mechanism capable of receiving and retaining the vehicle on said at least one carrier.

8. The apparatus as claimed in claim 7, wherein said at least one retention mechanism comprises at least one of a wheel fastener and a wheel basket.

9. The apparatus as claimed in claim 1, wherein said at least one direct drive is capable of selectively stopping the vehicle in an intermediary position with respect to said vehicle housing, said at least one direct drive capable of maintaining the vehicle in the intermediary position.

10. The apparatus as claimed in claim 1, wherein said vehicle housing comprises a platform on which a vehicle may be received.

11. An automated vehicle loading apparatus for use with a vehicle storage unit, said apparatus comprising:
a power source;
a motor;
at least one carrier, said at least one carrier capable of receiving at least a portion of a vehicle;
at least one guide, said at least one carrier operatively coupled to said at least one guide;
at least one direct drive, said at least one direct drive capable of moving said at least one carrier in a forward or rearward direction and
a control means,
wherein during a loading procedure, said control means directs said power source to cause said motor to operate said at least one direct drive to move said at least one carrier within said at least one guide in a direction along said at least one guide from a first position to a second position such that the vehicle may be at least partially received by the vehicle storage unit, and
wherein during an unloading procedure, said control means directs said power source to cause said motor to operate said at least one direct drive to move said at least one carrier within said at least one guide in a direction along said at least one guide from a second position to a first position such that the vehicle may be removed from the vehicle storage unit.

12. The apparatus as claimed in claim 11, wherein said at least one direct drive comprises one of a spindle drive and shaft arrangement, a rack and pinion arrangement, and an internal belt drive arrangement.

13. The apparatus as claimed in claim 11, wherein said apparatus further comprises a sensor, said sensor capable of deactivating said power source or directing said control means to deactivate said power source upon the vehicle reaching a predetermined received position within the vehicle storage unit, said sensor capable of overriding said control means.

14. The apparatus as claimed in claim 11, wherein said control means comprises at least one of remote controlling and direct controlling.

15. The apparatus as claimed in claim 11, wherein said at least one carrier further comprises at least one retention mechanism, said at least one retention mechanism capable of receiving and retaining the vehicle on said at least one carrier.

16. The apparatus as claimed in claim 15, wherein said at least one retention mechanism comprises at least one of a wheel fastener and a wheel basket.

17. The apparatus as claimed in claim 11, wherein said at least one direct drive is capable of selectively stopping the vehicle in an intermediary position with respect to the vehicle storage unit, said at least one direct drive capable of maintaining the vehicle in the intermediary position.

18. The apparatus as claimed in claim 11 wherein said apparatus further comprises at least one ramp, said at least one ramp forming a surface upon which a user may drive the vehicle to access said at least one carrier, said at least one ramp disposed at an end of the vehicle storage unit.

19. The apparatus as claimed in claim 18, wherein said at least one ramp may be coupled to the vehicle storage unit by one of hinged attachment and slidable extension.

20. The apparatus as claimed in claim 11, wherein the vehicle storage unit comprises one of a trailer, enclosure, and a platform.
